(19) United States
(12) Patent Application Publication
(10) Pub. No.: US 2005/0273401 A1
(43) Pub. Date: Dec. 8, 2005

(54) Cost comparing system and method

(76) Inventors: Pu-Yang Yeh, Tu-chen (TW); Ping Liu, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/863,309

(22) Filed: Jun. 7, 2004

(30) Foreign Application Priority Data
Jun. 6, 2004 (TW) 92115460

(51) Int. Cl. G06F 17/60

(52) U.S. Cl. 705/29

(57) ABSTRACT

A cost comparing system includes a plurality of client computers (10), an application server (12), and a database (14). The cost comparing system is connected to a manufacturing system (15), a supplier goods providing system (16), and a sales quoting system (17). Each client computer provides a user interface for inputting and obtaining information from the application server. The application server is for computing item costs and comparing costs with prices. The application server includes a basic information maintaining module (21), a BOM copying module (22), an outsourcing item cost posting module (23), a standard BOM computing module (24), an item cost collecting module (25), a price maintaining module (26), a comparing module (27), and a statement generating module (28). The database is for storing basic information, computing results, maintaining results, comparing results and generating statements. A related cost comparing method is also provided.

### BACKGROUND OF THE INVENTION

1. Field of the Invention

The present invention relates to cost comparing systems and methods, and particularly to a cost comparing system and method that can compare costs with prices according to kinds of costs.

2. Background of the Invention

Cost computation is vital for large-scale businesses such as manufacturing corporations. The traditional industry method is to compute costs of each month through work centers; that is, accountants carry forward costs of manufacturing steps to work centers, and compute total costs step by step. This method is usually done manually or electronically with Microsoft Excel files. In either case, the procedures require considerable manpower, and are prone to human error. Accountants often compute and update costs information only every two or three months. Furthermore, the method is problematic when costs are computed according to kinds of costs and cost structures. Accordingly, many modern manufacturing corporations have adopted computer and network technology to bring cost computation into the realm of e-business. The use of an electronic cost account computation system greatly improves efficiency in computing costs.

Cost comparing systems and methods are disclosed in a number of patents. U.S. Pat. No. 6,356,880 issued on Mar. 12, 2002 and entitled “Methods And Systems For Dynamic Cost Allocation Through Task Auto Assignment” discloses methods and systems for automatically assigning tasks to interrelated tasks according to a regulation. The methods and systems can obtain details of cost computation without limiting data sources of interrelated costs; and the methods and systems concentrate on cost assignments. However, the methods and systems do not provide for comparing costs with prices according to kinds of costs.

### SUMMARY OF THE INVENTION

Accordingly, a main objective of the present invention is to provide a cost comparing system and method which can compare costs with prices according to kinds of costs, the kinds of costs being material costs, manufacturing costs and supplementary costs.

To accomplish the above objective, a cost comparing system in accordance with a preferred embodiment of the present invention includes a plurality of client computers, an application server and a database. The cost comparing system is connected to a manufacturing system, a supplier goods providing system and a sales quoting system. Each client computer provides a user interface for inputting and obtaining information. The application server includes: a basic information maintaining module for maintaining all kinds of basic information; a bill of material (BOM) copying module for copying general BOM information to standard BOM cost information; an outsourcing item cost posting module for automatically posting basic information on outsourcing items to corresponding columns of a standard format BOM cost information table; a standard BOM cost computing module for computing standard BOM costs of items according to components and their cost levels; an item cost collecting module for collecting and respectively displaying item costs, which include material costs, manufacturing costs and supplementary costs; a price maintaining module for obtaining detailed price information on items from the sales quoting system; a comparing module for comparing costs with prices according to kinds of costs; and a statement generating module for generating statements according to conditions set by users. The client computers are connected to the application server through an electronic communication network. The application server is connected to the database through a database connectivity.

Further, the present invention provides a preferred cost comparing method comprising the steps of: (a) maintaining basic information through a user interface; (b) determining an item's attribute, and inputting an identifying code and posting basic information on the outsourcing item to corresponding columns of a standard format BOM cost information table if the item is an outsourcing item, or inputting a manufacturing code and automatically copying general BOM information to a standard format BOM cost information table if the item is a self-manufacturing item; (c) computing standard BOM costs; (d) collecting and respectively displaying item costs; which include a material cost or a manufacturing cost, and a supplementary cost; (e) maintaining price information; (f) comparing costs with corresponding prices; and (g) generating statements.

Other objects, advantages and novel features of the present invention will be drawn from the following detailed description with reference to the attached drawings, in which:

### BRIEF DESCRIPTION OF THE DRAWINGS

FIG. 1 shows relationships between various kinds of costs defined by a manufacturing enterprise in accordance with the preferred embodiment of the present invention;

FIG. 2 is a schematic diagram of hardware infrastructure of a cost comparing system in accordance with the preferred embodiment of the present invention;

FIG. 3 is a schematic diagram of main function modules of an application server of the cost comparing system of FIG. 2; and

FIG. 4 is a flowchart of the preferred method for implementing the cost comparing system of the present invention.

### DETAILED DESCRIPTION OF THE INVENTION

In the following description relating to a manufacturing enterprise, a “self-manufacturing item” is one that is processed or used by the manufacturing enterprise without any need for outsourcing. Once processed or used, the item or an assembly incorporating the item is sold to a customer. An “outsourcing item” is one that is provided to the manufacturing enterprise by an outsourcing company. Typically, the outsourcing company procures raw materials from a supplier, processes the raw materials, and sells the processed materials to the manufacturing enterprise. The manufacturing enterprise then further processes or uses said processed materials.

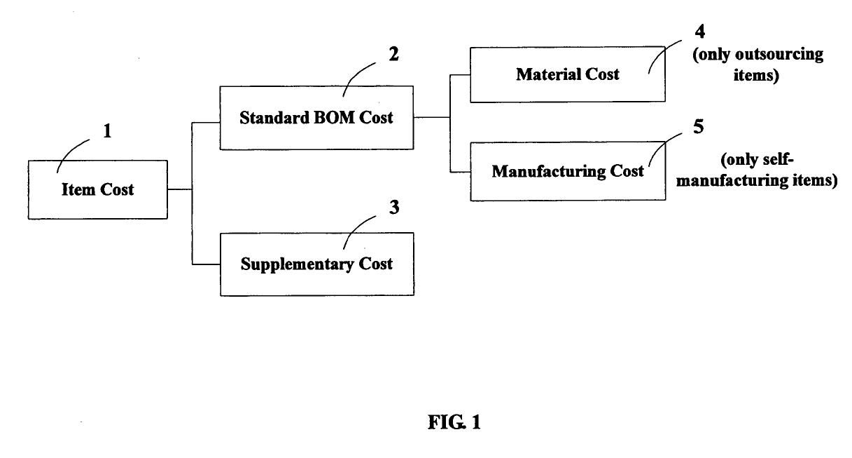

FIG. 1 shows relationships between various kinds of costs defined by the manufacturing enterprise in accordance with the preferred embodiment of the present invention. These costs are item cost 1, standard BOM cost 2, supplementary cost 3, material cost 4, and manufacturing cost 5. Item cost 1 comprises standard BOM cost 2 and supplementary cost 3. Standard BOM cost 3 comprises material cost 4 and manufacturing cost 5. In this description, material cost 4 means the total cost of an item sold to the manufacturing enterprise by an outsourcing company. Such total cost includes the cost of the original raw material procured by the outsourcing company, plus the outsourcing company's charge for processing the raw material. In this description, manufacturing cost 5 means the cost incurred by the manufacturing enterprise in processing a self-manufacturing item, and does not include the cost of procuring the self-manufacturing item from the supplier of the self-manufacturing item. Accordingly, an outsourcing item comprises a material cost 4 but does not comprise a manufacturing cost 5. Conversely, a self-manufacturing item comprises a manufacturing cost 5 but does not comprise a material cost 4. Supplementary cost 3 is the sum of other costs of an item apart from the material cost 4 or the manufacturing cost 5.

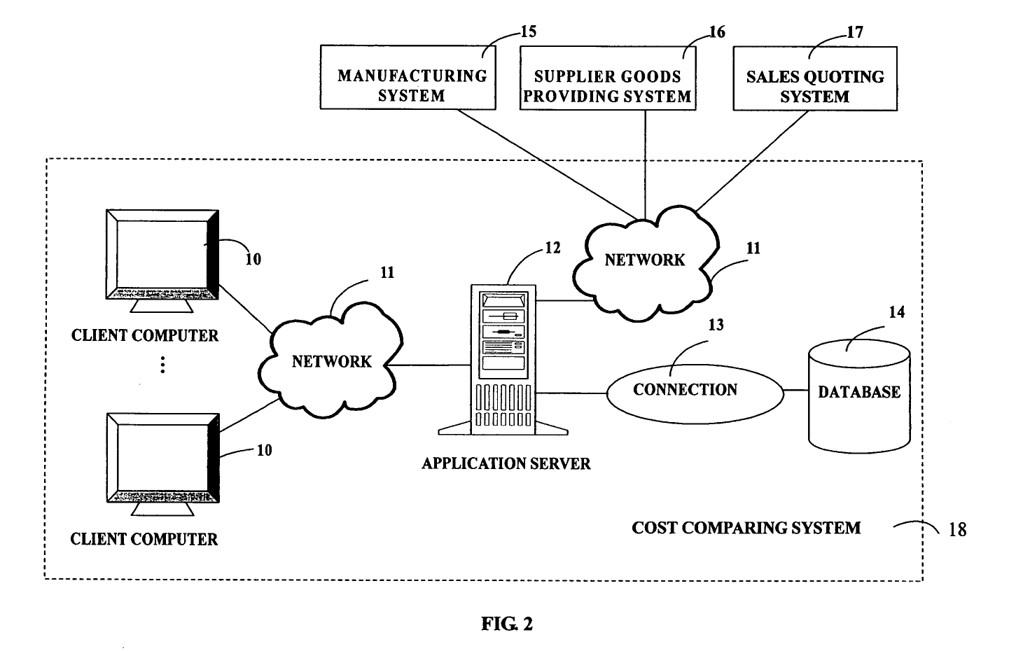

FIG. 2 is a schematic diagram of hardware infrastructure of a cost comparing system 18 in accordance with the preferred embodiment of the present invention. The cost comparing system 18 is employed by the manufacturing enterprise, and comprises a plurality of client computers 10, an application server 12 and a database 14. The cost comparing system 18 is connected to a manufacturing system 15, a supplier goods providing system 16 and a sales quoting system 17 through a network 11. The network 11 may be any suitable communication architecture required by the cost comparing system 18, such as a local area network or a wide area network. The manufacturing system 15 provides general bill of material (BOM) information for items. Each item is either a self-manufacturing item or an outsourcing item. A self-manufacturing item may be work-in-process, a semifinished product, or a finished product. Similarly, an outsourcing item may be work-in-process, a semifinished product, or a finished product. The general BOM information comprises numbers, names, quantities, wastage rates and attributes of all low level items used in a high lever item. In the preferred embodiment of the present invention, each item's attribute is either self-manufacturing or outsourcing. The supplier goods providing system 16 is employed by the manufacturing enterprise for providing information on outsourcing items, such information including numbers, names, prices and quantities of outsourcing items. The sales quoting system 17 provides detailed price information on items. The detailed price information includes numbers, names, material prices, manufacturing prices, supplementary prices and total prices of items.

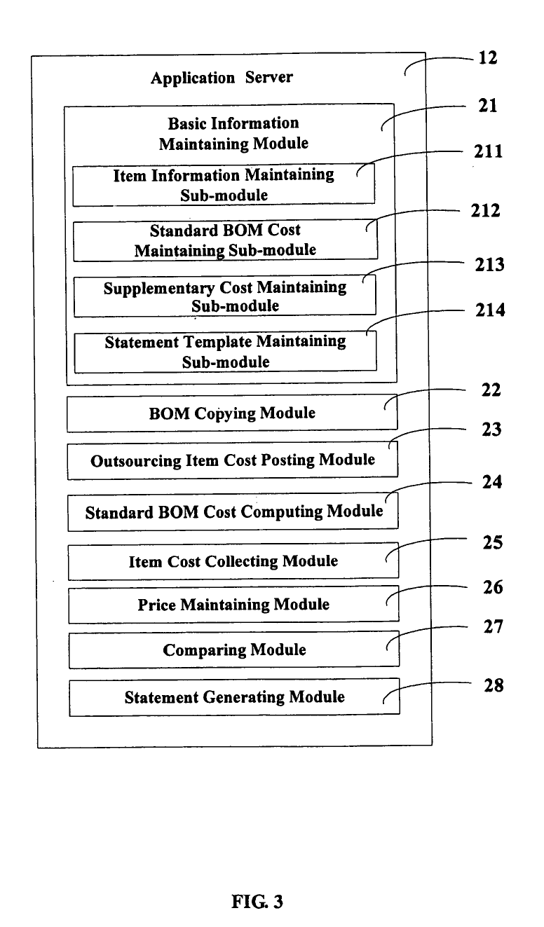

The client computers 10 are connected to the application server 12 through the network 11. The application server 12 is connected to the database 14 through a connection 13. The connection 13 is a database connectivity, such as an ODBC (Open Database Connectivity) or a JDBC (Java Database Connectivity). Each of the client computers 10 provides a user interface for users to maintain information. The application server 12 comprises a plurality of function modules, which are described in detail below in relation to FIG. 3. The database 14 stores all kinds of data used and generated in the above-described processes.

FIG. 3 is a schematic diagram of main function modules of the application server 12. The application server 12 comprises a basic information maintaining module 21, a BOM copying module 22, an outsourcing item cost posting module 23, a standard BOM cost computing module 24, an item cost collecting module 25, a price maintaining module 26, a comparing module 27, and a statement generating module 28.

The basic information maintaining module 21 maintains all kinds of basic information, including by way of adding, modifying, searching, deleting, coping and printing basic information. The basic information includes item information, standard BOM costs, supplementary costs and statement templates, all of which are stored in the database 14. The basic information maintaining module 21 comprises an item information maintaining sub-module 211, a standard BOM cost maintaining sub-module 212, a supplementary cost maintaining sub-module 213, and a statement template maintaining sub-module 214. The item information maintaining sub-module 211 maintains item information. Such item information includes numbers, names, units, specifications, source codes, identifying codes, manufacturing codes, and so on. A source code indicates an item's attribute according to a predetermined symbol; for example, P represents an outsourcing item and M represents a self-manufacturing item. An identifying code or manufacturing code is determined by an item's source code, and indicates the item's further attribute. The item's further attribute is used for management purposes, or for limiting the item's cost in computing procedures. When a source code indicates an outsourcing item, the outsourcing item is further marked with an identifying code. For example, ten different basic components of the item are represented by the numbers 1 through 10. If the identifying code is 6, this indicates one particular component of the item. When a source code indicates a self-manufacturing item, the self-manufacturing item is further marked with a manufacturing code. For example, six different processing schedules for the item are represented by the numbers 1 through 6. If the manufacturing code is 2, this indicates one particular processing schedule for the item. The processing schedules are procedures for manufacturing an item, such as stamping, molding and painting. The standard BOM cost maintaining sub-module 212 sets and maintains standard BOM cost information. The standard BOM cost information comprises a component structure and standard times. Columns of the standard BOM cost information include edition, number, name, source code, identifying code or manufacturing code, component, standard QPA, labor cost apportioned per hour, manufacturing cost apportioned per hour, standard time, unit cost, material cost, supplementary cost, and so on. The edition relates to a requested year and month, because fluctuations in standard BOM costs can occur yearly or even monthly. The standard QPA is a standard quantity of each component used in an item. The unit cost for each item is calculated using different computing methods, depending on the item's attribute. That is, the unit cost of an outsourcing item is the purchasing unit price, and the unit cost of a self-manufacturing item is the sum of labor costs apportioned per hour and manufacturing costs apportioned per hour. The supplementary cost maintaining sub-module 213 maintains supplementary costs. The statement template maintaining sub-module 214 maintains types, layouts and formats of statements. The statement types comprise a supplementary cost searching statement, an item cost searching statement, a detailed cost searching statement, and a comparison table.

The BOM copying module 22 obtains general BOM information on a self-manufacturing item from the manufacturing system 15 according to a predetermined standard (such as a beginning number or an ending number), and automatically copies the general BOM information to a standard format BOM cost information table according to predetermined columns. The columns are maintained by the standard BOM cost maintaining sub-module 212. The copied standard format BOM cost information table is stored in the database 14.

The outsourcing item cost posting module 23 obtains information on an outsourcing item from the supplier goods providing system 16, and posts the information to corresponding columns of a standard format BOM cost information table. The columns are maintained by the standard BOM cost maintaining sub-module 212. The standard format BOM cost information table is stored in the database 14.

The standard BOM cost computing module 24 computes standard BOM costs of items. This is done by way of calculating step by step from low level components to high level components, or from high level components to low level components. The components and their levels are maintained by the standard BOM cost maintaining sub-module 212. The result of each level is stored in the database 14. With this framework, the standard BOM cost computing module 24 can easily compute the standard BOM cost of each item no matter what level it belongs to, according to a predetermined standard. The predetermined standard can be a beginning number, an ending number, one specified number, more than one specified number, and so on. A standard BOM cost of each requested item is stored in the database 14.

The item cost collecting module 25 obtains supplementary cost information on a requested item from the supplementary cost maintaining sub-module 213, adds the supplementary cost to the standard BOM cost of the item, and thereby obtains a resulting item cost. The item cost is displayed with its applicable component supplementary cost, material cost and manufacturing cost. The item cost is stored in the database 14.

The price maintaining module 26 obtains detailed price information on items from the sales quoting system 17, and stores results in the database 14. The detailed price information includes item numbers, names, material prices, manufacturing prices, supplementary prices, and total prices.

The comparing module 27 obtains detailed price information on and item costs of a particular item from the database 14, and compares the material prices, manufacturing prices and supplementary prices of the item with the details of the corresponding item costs. The comparing module 27 automatically computes differences between the above-described costs, and obtains a gross margin of each cost.

The statement generating module 28 obtains results and corresponding statement templates according to parameters set by users, in order to generate requested statements. The parameters include item number, cost, identifying code or manufacturing code, and so on.

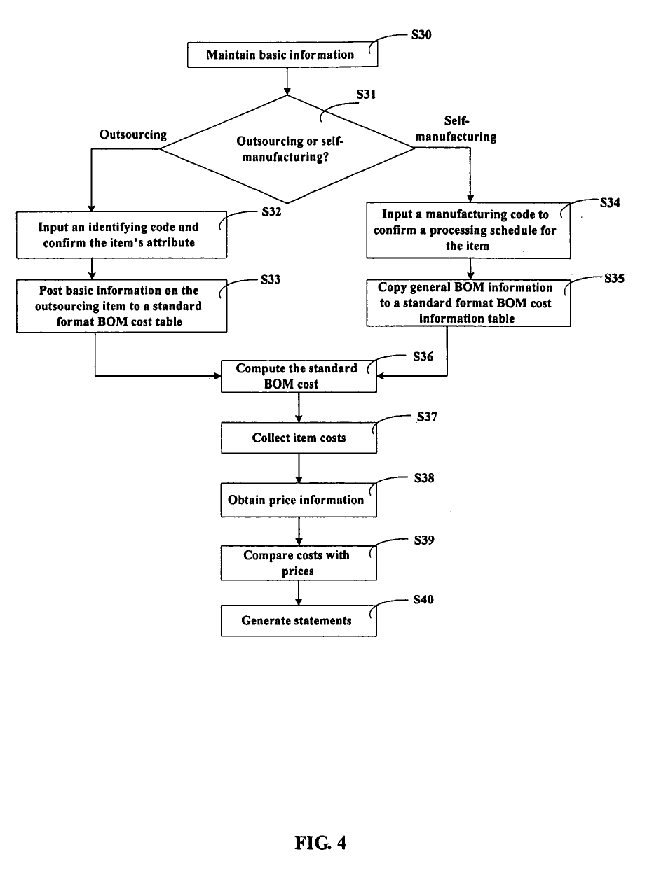

FIG. 4 is a flowchart of a preferred method for implementing the cost comparing system of the present invention. In step S30, the basic information maintaining module 21 sets and maintains basic information. The basic information is stored in the database 14, and can be searched by any user from any client computer 10. In step S31, the basic information maintaining module 21 determines whether an item is an outsourcing item or a self-manufacturing item. If the item is an outsourcing item, in step S32, an identifying code is input to further confirm the item's attribute. Then in step S33, the outsourcing item cost posting module 23 obtains basic information on the outsourcing item from the supplier goods providing system 16 according to a predetermined standard, and automatically posts the information to corresponding columns of a standard format BOM cost information table. The standard format BOM cost information table is stored in the database 14. Thereupon the procedure goes to step S36 described below.

If the item is a self-manufacturing item, in step S34, a manufacturing code is input to confirm a processing schedule for the item. Then in step S35, the BOM copying module 22 obtains general BOM information on the self-manufacturing item from the manufacturing system 15, and automatically copies the general BOM information to a standard format BOM cost information table according to predetermined columns. The columns are maintained by the standard BOM cost maintaining sub-module 212. The copied standard format BOM cost information table is stored in the database 14. Thereupon the procedure goes to step S36 described below.

In step S36, if the item is an outsourcing item, the standard BOM cost computing module 24 reads component unit prices and standard QPA obtained from the standard BOM cost maintaining sub-module 212, multiplies them to obtain a material cost of each component of the item, and computes a material cost of the item by way of collecting the material cost of each component from low levels to high levels. The results are stored in the database 14. If the item is a self-manufacturing item, the standard BOM cost computing module 24 reads component unit prices, standard QPA and standard times obtained from the standard BOM cost maintaining sub-module 212, multiplies them to obtain a manufacturing cost of each component of the item, and computes a manufacturing cost of the item by way of collecting the manufacturing cost of each component from low levels to high levels. The results are stored in the database 14. In step S37, the item cost collecting module 25 collects and displays the item's costs, which include the applicable material cost or manufacturing cost, and the item's supplementary cost. In step S38, the price maintaining module 26 obtains detailed price information on requested items from the sales quoting system 17. In step S39, the comparing module 27 compares costs with prices of the item according to each kind of cost, and automatically computes a corresponding difference and a gross margin of each kind of cost. The kinds of costs include the applicable material cost or manufacturing cost, and the item's supplementary cost. In step S40, the statement generating module 28 generates statements. The statements are displayed to a user through a user interface, and can be printed and saved.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A cost comparing system which comprises a plurality of client computers that are connected with an application server through a network, wherein the application server is connected to a database through a database connectivity, and:
each of the client computers provides a user interface for inputting and displaying data; and
the application server is for automatically comparing costs with prices, and comprises:
a standard bill of material (BOM) cost computing module for computing standard BOM costs of items;
an item cost collecting module for collecting and displaying item costs;
a price maintaining module for obtaining and maintaining detailed price information on items; and
a comparing module for comparing costs with prices of items.

2. The cost comparing system according to claim 1, wherein the application server further comprises a basic information maintaining module for adding, modifying, searching, deleting, copying and printing basic information, the basic information maintaining module comprising:
an item information maintaining sub-module for maintaining item information;
a standard BOM cost maintaining sub-module for setting and maintaining standard BOM cost information;
a supplementary cost maintaining sub-module for maintaining supplementary costs; and
a statement template maintaining sub-module for maintaining statement types, layouts and formats.

3. The cost comparing system according to claim 1, wherein the application server further comprises a BOM copying module for automatically copying general BOM information to a standard BOM cost information document.

4. The cost comparing system according to claim 1, wherein the application server further comprises an outsourcing item cost posting module for posting basic information on outsourcing items to a standard BOM cost information document.

5. The cost comparing system according to claim 1, wherein the application server further comprises a statement generating module for generating various kinds of statements according to conditions set by users and corresponding statement templates.

6. A computer-enabled cost comparing method, comprising the steps of:
maintaining basic information;
computing a standard bill of material (BOM) cost of an item;
collecting the item's costs;
maintaining price information on the item; and
comparing costs with corresponding prices.

7. The cost comparing method according to claim 6, further comprising the steps of:
determining whether the item is an outsourcing item or a self-manufacturing item; and
inputting an identifying code and automatically posting outsourcing standard BOM costs if the item is an outsourcing item; or
inputting a manufacturing code and copying general BOM information to a standard BOM cost information document if the item is a self-manufacturing item.

8. The cost comparing method according to claim 6, wherein the step of comparing costs with prices comprises the steps of: obtaining detailed price information on the item and detailed costs of the item, comparing the costs with the prices according to each kind of cost, and automatically computing the difference and a gross margin of each kind of cost.

9. The cost comparing method according to claim 8, wherein the kinds of cost include material cost and/or manufacturing cost, and supplementary cost.

10. The cost comparing method according to claim 6, further comprising the step of automatically generating corresponding statements according to terms set by one or more users.

11. A cost comparing system which comprises a plurality of client computers that are connected with an application server through a network, wherein the application server is connected to a database through a database connectivity, further comprising:
means for maintaining basic information;
means for computing a standard bill of material (BOM) cost of an item;
means for collecting the item's costs;
means for maintaining price information on the item; and
means for comparing costs with corresponding prices.
